(19) United States
(12) Patent Application Publication
(10) Pub. No.: US 2014/0201766 A1
(43) Pub. Date: Jul. 17, 2014

(54) PLAY USAGE STATISTICAL SYSTEM

(71) Applicant: RAWLLIN INTERNATIONAL INC., Tortola (VG)

(72) Inventors: Sergey Stepanov, Sankt-Petersburg (RU); Dmitry V. Loginov, Saint-Petersburg (RU); Evgeny Dolgov, Saint-Petersburg (RU)

(73) Assignee: RAWLLIN INTERNATIONAL INC., Tortola (VG)

(21) Appl. No.: 13/742,251

(22) Filed: Jan. 15, 2013

(51) Int. Cl. H04N 21/80

(52) U.S. Cl. CPC H04N 21/80
USPC 725/9

(57) ABSTRACT

Viewing history regarding one or more instances of media content is generated for subsequent analysis. The viewing history is developed based on recording timestamps associated with one or more instances that viewing of the media content is interrupted, paused, terminated, etc. The timestamps can be supplemented with metadata associated with the media content (e.g., media title, genre, duration, actor, actress, etc.) along with information collected from the communication system conveying the media content. By data mining the timestamps in conjunction with other pertinent data it is possible to determine why a viewer may not have viewed the media content in its entirety, as well as recommend future content. Analysis of the viewing history can be performed in conjunction with previously stored viewing histories, along with other viewers viewing histories, etc., to gain a broader understanding of a viewing history for a given media content.

### TECHNICAL FIELD

The subject specification relates generally to media systems, e.g., monitoring of interaction with media to identify further media for presentment.

### BACKGROUND

A multitude of content is available via communication systems, such as the Internet, cable, satellite, etc. Typically, such communication systems have applications operating thereon which recommend content based on previously viewed content, where the previously viewed content is identified by metadata comprising for example, movie title, genre, actor(s), actress(es), etc. The viewing history of a person can be compiled with analysis of the metadata being utilized to determine recommended content. For example, analysis of the viewing history indicates a person watches a lot of sci-fi genre movies and hence other movies identified as ‘sci-fi’ are presented to the viewer, where the presented movies can be further filtered based on actor(s), actress(es), etc.

Such an approach can help viewers be presented with movies in which they have an interest. However, such an approach does not take into consideration other factors relating to a viewer's interest and hence the operation of simply assessing viewing trends based on metadata associated with a movie may not accurately capture other viewing criteria and/or interests.

### SUMMARY

The following presents a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification as a prelude to the more detailed description that is presented later.

In accordance with one or more embodiments and corresponding disclosure, various non-limiting aspects are described in connection with determining viewing relating to media content. In an exemplary, non-limiting embodiment, a system is described for monitoring viewing of media content, the system comprising a timestamp component configured to determine interruption in viewing of media content and generate a timestamp indicating the interruption. The system can further comprise a media determination component configured to review the timestamp in conjunction with at least one other timestamp associated with the media content and can determine, based on the review, future media content. The system can further comprise a report component configured to generate a report comprising the review. The media content can comprise a movie, a documentary, a news program, television program, an episode in a television series, computer game, audio content, a digital image, or a digitally rendered photograph. In another embodiment, the timestamp can be supplemented with data relating to the viewing of the media content, where the data can comprise at least one of a device utilized to view the media content, a location of viewing the media content, a network facilitating delivery of the media content, a time of viewing the media content, a cause of interruption in viewing of the media content, a duration of interruption in viewing of the media content, or whether the media content was viewed to completion.

In a further embodiment, the media determination component can be further configured to receive information from at least one device associated with a network facilitating delivery of the media content, wherein the at least one device can be a camera, a webcam, a security camera, a phone monitoring component, an email monitoring component, or an internet monitoring component. Further, the information can comprise at least one of a phone call being received, an email being received, a visitor, an activity of a viewer watching the media content, or internet activity of a viewer watching the media content.

The system can further comprise an input component, the input component configured to receive viewer input regarding the media content, wherein the viewer input can supplement information comprising the timestamp. A data storage component can be utilized with the system to store at least one of the timestamp, a user profile, a report, feedback, viewer input, or a response to a questionnaire. A camera component can be configured to identify at least one viewer of the media content, and a position of the at least one viewer during presentation of the media content.

In another exemplary, non-limiting embodiment, a method is described that can facilitate determining a viewing history of media content. The method includes determining an interruption in viewing of media content, generating a timestamp indicating the interruption, analyzing the timestamp in conjunction with at least one other timestamp associated with the media content, and determining, based on the analyzing, future media content. The method can further comprise supplementing the timestamp with data relating to viewing of the media content, wherein the data can indicate at least one of a device facilitating viewing of the media content, a location of viewing the media content, a network facilitating delivery of the media content, a time of viewing the media content, a cause of interruption in viewing of the media content, a duration of interruption in viewing of the media content, or whether the media content was viewed to completion. The method can further include receiving information from at least one device associated with a network facilitating delivery of the media content, wherein the at least one device being a camera, a webcam, a security camera, a phone monitoring component, an email monitoring component, or an internet monitoring component. In another, exemplary, non-limiting embodiment the method can further comprise storing at least one of the timestamp, a user profile, a report, feedback, viewer input, or a response to a questionnaire.

In another exemplary, non-limiting embodiment, a non-transitory computer readable storage medium is presented comprising computer executable instructions that, in response to execution, can cause a computing system comprising a processor to perform operations, comprising determining an interruption in viewing of media content, generating a timestamp indicating the interruption, analyzing the timestamp in conjunction with at least one other timestamp associated with the media content and determining, based on the analyzing, future media content. In another exemplary, non-limiting embodiment, the operations can further comprise supplementing the timestamp with data relating to viewing of the media content, where the data can indicate at least one of a device facilitating viewing of the media content, a location of viewing the media content, a network facilitating delivery of the media content, a time of viewing the media content, a cause of interruption in viewing of the media content, a duration of interruption in viewing of the media content, or whether the media content was viewed to completion.

### BRIEF DESCRIPTION OF THE DRAWINGS

FIG. 1 is a block diagram illustrating exemplary, non-limiting embodiments of a media determination system.

FIG. 2 is a block diagram illustrating exemplary, non-limiting embodiments of a media determination system.

FIG. 3 is a block diagram illustrating exemplary, non-limiting embodiments of a media determination system.

FIG. 4 illustrates a timestamp table in accordance with one or more embodiments of the subject disclosure.

FIG. 5 illustrates a flow for determining viewing interest in accordance with one or more embodiments of the subject disclosure.

FIG. 6 illustrates a flow for determining viewing interest in accordance with one or more embodiments of the subject disclosure.

FIG. 7 illustrates a flow for determining viewing interest in accordance with one or more embodiments of the subject disclosure.

FIG. 8 is an example computing environment.

FIG. 9 is an example networking environment.

### DETAILED DESCRIPTION

The various embodiments are now described with reference to the drawings, wherein like reference numerals are used to refer to like elements throughout. In the following description, for purposes of explanation, numerous specific details are set forth in order to provide a thorough understanding of the various embodiments. It can be evident, however, that the various embodiments can be practiced without these specific details. In other instances, well-known structures and devices are shown in block diagram form in order to facilitate describing the various embodiments.

### Media Content Analysis

The subject disclosure presents various systems and methods relating to monitoring interaction with media content (e.g., a movie, documentary, televised event, etc.) to identify which media content is of interest to an individual, or group of individuals, based on such parameters as viewing time, activity of the individual while the media content is being presented, temporary or permanent cessation of viewing, location of viewing, viewing device, etc. By monitoring an interest in media content, subsequent analysis of data gathered during the monitoring activity can facilitate determination of the type of content which is likely to capture a viewer's interest, and further, can enable other content to be recommended to the viewer. Furthermore, results of the data analysis can be forwarded to other parties having an interest in the current/future media content, where such parties can include, for example, a television network providing content, a participant in generation of media content (e.g., an entity providing media financing, a film company, etc.), a distributor of media content, a telecommunications service provider (e.g., cable network, satellite network, internet provider, etc.). Hence, by monitoring, and generating associated data, regarding an individual's interest in media content, it is possible to generate a wealth of knowledge and information of interest not only to the individual viewing the media content but any entity associated with generation and/or distribution of media content. A media determination system in conjunction with media provider component(s), viewing component(s), etc., can comprise a satellite system, a cable television system, an optical storage disc (e.g., a digital video disc—DVD) system, or other system suitable for incorporation of the various exemplary, non-limiting embodiments presented herein.

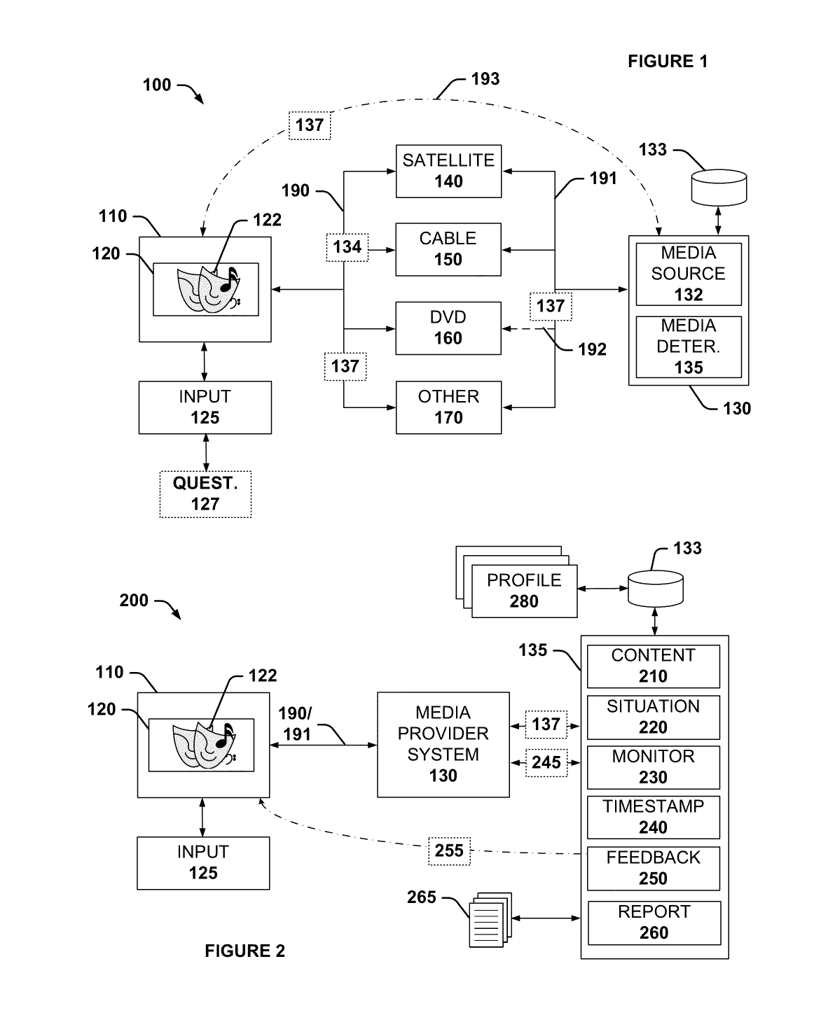

FIG. 1 illustrates an exemplary, non-limiting embodiment of a media determination system 100 to facilitate monitoring of interest in media content and identifying other content of interest. A viewing device 110 including a display 120 can be utilized to present/view media content 122. It is to be appreciated that viewing device 110 (and display 120) can be any device suitable for presentation of media content 122, for example, viewing device 110 can comprise of a television, a projection display system, a computer, a laptop computing device, a tablet computing device, a mobile phone, a cellular phone, a satellite phone, a media system, a gaming system, in car display, and the like. Further, while media content 122 is depicted as comprising stylized musical content, media content 122 can comprise of any media which can be monitored, an interest determined, future content identified based thereon, etc. For example, media content 122 can comprise of a movie, a documentary, a news program, television program, an episode in a television series, computer game, audio content (e.g., audio content on a compact disc (CD), a record, cassette, online streamed audio content, etc.), a digital image, a digitally rendered photograph, etc.

Associated with (i.e., directly attached to, communicatively coupled to, etc.) viewing device 110 and display 120 is an input component 125, where input component 125 can be utilized to facilitate interaction with the media content 122. For example, input component 125 can be utilized to enter data (e.g., data 137) regarding preferred content to be viewed, a reason for why viewing was terminated, etc., where the preferred content data 137 can be utilized to facilitate determination of further media content 122 for presentment on display 120. In an alternative embodiment, input component 125 can be utilized to respond to questions, etc., during and/or after viewing of media content 122. For example, a questionnaire 127 can be presented on display 120, with answers being provided via input component 125, where the answers can be utilized to supplement data 137 generated by monitoring of viewing of media content 122 as described further herein.

Media content 122 can be provided by any suitable source, where suitable sources, as depicted in FIG. 1, include a satellite-based communications system 140 (e.g., satellite television, direct broadcast satellite (DBS), etc.), a cable-based/network-based communications system 150 (e.g., cable television, streaming content via a network such as a wide area network (WAN), a local area network (LAN), an intranet, internet, etc.), a local media source 160 (hereinafter referred to as DVD 160) such as a DVD player, video cassette player (VCR), video recorder, digital video recorder (DVR), a computer (e.g., a personal computer co-located with viewing device 110 or comprising viewing device 110), a storage device containing media content such as a universal serial bus (USB) storage device, a hard drive, etc., and any other device/network 170 suitable for provisioning media content 122. Any of the systems/devices 140, 150, 160, or 170 can be operating local to the viewing device 110, or can be operating remotely from viewing device 110, as depicted in communication links 190, 191, and 192.

As further shown in FIG. 1, any of the systems/devices 140, 150, 160, or 170 can be connected, via communication links 191 and 192, to a media provider system 130 (e.g., a telecommunications provider system), where media provider system 130 can provide media content 122 for presentation on viewing device 110. As indicated by the unbroken lines of communications path 190 and 191, media provider system 130 can be in direct communication with viewing device 110, with media source component 132 (in conjunction with a data store 133) acting as a source for media content 122. For example, media provider system 130 can be transmitting media content 122 from media source component 132 to viewing device 110 in a live/streaming fashion, e.g., via cable-based communications system 150 and communications paths 191 and 190. Data store 133 can be utilized to act as a storage system for storing media content 122 (e.g., digital content such as movies, television shows, etc.) along with storing any data (e.g., data 137) which is generated during operation of the various components comprising system 100.

Similarly, any data 137 generated regarding viewing of media content 122 can be transferred between any respective components comprising system 100 via communication links 190 and 191. Data 137 can comprise of any information relating to the various embodiments presented herein, for example, metadata associated with the media content 122 (e.g., film title, film genre, year of release, awards won, awards nomination, actor(s), actress(es), color content, black and white content, foreign, subtitled, film length, etc.), a period(s) for which the media content 122 was viewed (e.g., entirety, paused at time P, re-started after time R, viewing terminated at time T, etc.), equipment (e.g., viewing device 110) on which media content 122 was viewed, equipment providing content (e.g., any of satellite-based communications system 140, cable-based/network-based communications system 150, a local media source 160, other network/device 170, etc.), location during viewing, a viewer, a plurality of viewers, result(s) of viewing data analysis, recommended viewing content, etc., as will be further expanded upon herein.

In another embodiment, while a source of media content 122 is not operated by media provider system 130, e.g., DVD system 160, it is possible for data 137 to be transmitted between the source of media content 122 and media provider system 130. For example, as indicated by broken line 192, data can be communicated between DVD system 160 and media provider system 130 by any suitable secondary means such as a USB modem/dongle (not shown), an internet connection, intranet, satellite communications, radio communications, etc. Further, in another embodiment, viewing device 110 can be in direct communication with media provider system 130, as indicated by communication path 193, where communication path 193 can be of any suitable means such as a cellular phone network, a satellite network, a LAN, a WAN, intranet, intranet, etc. Hence, by utilizing communication path 193, data 137 can be transmitted between viewing device 110 and media provider system 130 even in a situation where, ordinarily, viewing device 110 would not be associated with media provider system 130, such as, for example, where viewing device 110 is not typically subscribed to a service provided by media provider system 130.

Located at media provider system 130 is a media determination component 135 (herein after MDC 135), where MDC 135 can be utilized to monitor an interest in media content 122, perform subsequent analysis of data 137 gathered during the monitoring operation to determine the type of content which is likely to hold a viewer's interest, and further, can enable other content to be recommended to the viewer. Furthermore, MDC 135 can, based on the monitoring/data analysis, forward the results of the data analysis to other parties having an interest in the current/future media content. It is to be appreciated that while MDC 135 is depicted as being a component located at media provider system 130, the various exemplary embodiments presented herein are not so limited. Accordingly, MDC 135 (and any components comprising MDC 135, as described further herein) can be located anywhere throughout system 100 depicted in FIG. 1. For example, MDC 135 can reside at viewing device 110, at any of components 140, 150, 160, and/or 170, etc., to facilitate the various operations as presented herein.

In an exemplary scenario of operation, in accordance with the various embodiments presented herein, a request 134 for media content can be generated at viewing device 110 (e.g., via input component 125), where in an exemplary embodiment viewing device 110 is communicatively coupled to media provider system 130 via cable-based communications system 150. In response to receiving request 134, the content of request 134 can be analyzed to determine the media content 122 to be retrieved from data store 133 and forwarded for presentment on viewing device 110. Upon presentment of data on viewing device 110, the degree of interest of a viewer can be monitored, as further described herein. During the monitoring operation data 137 can be generated regarding a degree of interest the viewer has in media content 122. Degree of interest can be based on such parameters as viewing time, viewing paused, viewing resumed, activity of the individual(s) while the media content is being played, temporary or permanent cessation of viewing, location of viewing, viewing device, etc. Data 137 can be analyzed by MDC 135, and further, data 137 can be stored in data store 133, hence newly received data can be analyzed in isolation as well as with reference to other data previously generated with reference to viewing device 110. The data analysis can result in identifying that a plurality of media content 122 presented on viewing device 110 with a particular actor in the cast has been watched in their entirety (e.g., each movie has been watched to completion) and thus other media content associated with the actor can be retrieved from data store 133 for potential presentment on viewing device 110.

FIG. 2 illustrates an exemplary, non-limiting embodiment of a media determination system 200 to facilitate monitoring of interest in media content and identifying other content of interest. As illustrated in FIG. 2, media content 122 is available to be displayed on viewing device 110/display 120. As previously mentioned, user interaction/feedback can be provided via input component 125, with media content 122 being provided by media provider system 130, and data 137 being communicated between viewing device 110 and media provider system 130. To facilitate analysis of data 137, determination of new media content 122, etc., a plurality of components can be incorporated into MDC 135. A content component 210 can be utilized to identify content comprising media content 122, along with any other media content stored in data store 133. As previously mentioned, data 137 can be generated to identify information regarding the media content 122 such as film title, actor(s), actress(es), etc. In an embodiment, data 137 can be metadata associated with media content 122 and is readily available to content component 210, e.g., media content stored in data store 133 has associated descriptive metadata to facilitate retrieval, analysis, storage, etc., of the media content. Further, where media content 122 is not provided by media provider system 130 (e.g., the media content is not sourced from data store 133) it can still be possible to obtain data regarding the media content 122. With reference to FIG. 1, communication link 192 can be utilized to facilitate transmission of data 137 between a non-hosted device (e.g., DVD 160) and the MDC 135. Hence, metadata on a DVD can be read by DVD component 160 and conveyed to MDC 135, thus enabling MDC 135 to have knowledge of what DVD is being played even though the DVD may not have been supplied by media provider system 130. With further reference to FIG. 1, communication link 193 can be utilized to facilitate transmission of data 137 between viewing device 110 and MDC 135. Furthermore, as previously mentioned, input component 125 can be utilized to receive information from an operator of viewing device 110, for example, a response via input component 125 to a questionnaire, or for example, submitting an entry to a user profile 280 associated with viewing device 110, where user profile 280 can be stored in data store 133.

A situation component 220 can be utilized to identify a location, and other situational information, pertaining to viewing of media content 122. For example, viewing device 110 may be located at a viewer's residence (e.g., a television in the living room) and knowledge of the location of viewing can supplement metadata regarding the content of media content 122 being viewed. In a further embodiment, analysis of data 137 can reveal that certain content is primarily viewed in a first location (e.g., family based movies are viewed on the television in the living room) while other content is primarily viewed in a second location (e.g., sports are viewed on the television in the basement). The location can be determined by an ancillary process such as identifying a location of viewing device 110 based upon the system which is delivering media content 122. For example, situation component 220 can identify that media content 122 is being requested via a particular network access point, the network access point is known to be associated with a particular hotel in a given city, and hence it is deduced that viewing device 110 is located at the particular hotel. The type of media content 122 viewed during each time the viewing device 110 is at the hotel can be analyzed and, based thereon, future media content 122 can be made available during a subsequent stay at the hotel, e.g., business related media content. It is to be appreciated that any suitable means for determining situation of viewing can be utilized, for example, a global positioning system (GPS) or other locating system for a device can indicate the device is being used in a mobile or static manner. In another aspect, ‘what network is the content being streamed via?’ can be determined. In a further aspect, certain media content 122 can be viewed on DVD component 160 as opposed to being streamed via cable-based communications system 150, where a higher level of image quality is provided by DVD component 160 (e.g., DVD component 160 is a BLU-RAY player). Further, more than one DVD component 160 may be located in a household, where certain content is viewed on a first DVD component 160 (e.g., is located in a child's room and used to view media content 122 directed towards an 8-12 age group) where certain content is viewed on a second DVD component 160 (e.g., music concerts on a DVD component 160 located in a teenagers room). In another embodiment, location of a device can be identified based on an activity performed thereon. For example, a DVD player is known to always be located at a house, as firmware upgrades are always performed on the network providing content to the house.

Monitoring component 230 can be utilized to monitor a viewer's activity while media content 122 is presented on viewing device 122. In an aspect, how often/the duration which a person pauses and then resumes playing media content 122 can be monitored. At each pause event, a timestamp 245 can be associated with data 137 (e.g., by timestamp component 240) indicating a time at which viewing of the content was paused, e.g., at a particular point in media content 122, at a particular time of the day (for example, enabling media content to be identified based on time of viewing), on a particular day of the week, etc. Further, if viewing of media content 122 is resumed, a second time stamp 245 can be generated to indicate the time at which viewing was resumed. Hence, it is possible to simply identify whether viewing was resumed. In another aspect, if viewing of media content 122 is terminated (e.g., a television is turned off) a timestamp 245 can be generated indicating the time of viewing termination. If viewing of media content 122 is subsequently resumed (e.g., 3 months later) monitoring of viewing can be resumed to determine whether viewing of media content 122 is re-commenced from the start or whether viewing of media content 122 is resumed at a point in the content, e.g., viewing is resumed from the point where viewing was previously terminated. For example, where media content 122 is a football match and the first half of the game was viewed before viewing was terminated, a timestamp 245 was generated indicating the time of viewing termination and the point in the match (e.g., halftime), with subsequent viewing resuming at halftime. In another aspect, it is possible to monitor any action being performed in relation to media content 122, for example, rewind, skip, go to chapter, return to chapter, etc.

As previously mentioned, data generated by a plurality of components can be combined in data 137. For example, where viewing of media content 122 is paused, it is possible to determine a reason for viewing to be paused. For example, where a mobile device is being utilized to view media content 122, was viewing of media content 122 paused as a result of a phonecall being received at the mobile device?, whereupon after termination of the phonecall, was viewing of media content 122 resumed? If yes, then it is possible to make a conjecture that the interruption in viewing of media content 122 was due to a phonecall being answered, as opposed to another event, where a timestamp 245 can be generated with an associated reason ‘phonecall’. In another aspect, where media content 122 was being viewed on a viewing device 122 that supports a plurality of communication mechanisms (e.g., a laptop, a networked television, etc.), was viewing of the media content paused, for example, in response to an email being received at the viewing device 122, where a timestamp 245 can be generated with an associated reason ‘email’.

In another example, viewing device 122 can be associated with a network communication bundle (e.g., a network at a home comprising internet, digital television, telephone, etc.) where media content 122 is provided by a cable-based communications system 150, while other devices are associated with the network, such as a security camera. Thus, if viewing is terminated, it is possible to identify from the security camera whether someone was at the door, a timestamp 245 can be generated with an associated reason ‘visitor’. In another embodiment, viewing device 110 can be a computer system comprising a video camera (e.g., a webcam) where upon viewing of media content 122 being paused it is possible to activate the video camera to determine if the viewer is still in the locality, they have left the room, etc. Hence, a timestamp 245 can be generated with an associated reason ‘at computer’, or alternatively, a timestamp 245 can be generated with an associated reason ‘not at computer’. Continuing the example further, by monitoring the images generated by the video camera it can be possible to identify whether another person is in the locality of viewing device 110 and hence a determination can be made that the viewer is no longer viewing media content 122 as they are in conversation with the another person, with a timestamp 245 can be generated with an associated reason ‘other person’. In another embodiment, it can be possible to utilize the video camera such as a webcam operable on a laptop which is being used to view media content 122, to identify an activity pertaining to why a viewer may no longer be viewing media content 122, e.g., the viewer is asleep, with a timestamp 245 can be generated with an associated reason ‘sleeping’.

In a further embodiment, while the preceding has focused on the viewing interest of an individual, it is also possible to analyze viewing profiles associated with a plurality of other viewers. Such an analysis enables trends to be identified with regard to media content 122 and the interest it generates, or not, in the plurality of viewers. For example, timestamps from a plurality of viewing profiles can be analyzed with regard to a particular movie, Movie X, where it is determined that the majority of viewers terminate viewing of the movie after about, for example, approximately 23 minutes. Upon subsequent review of the movie, it is determined that a particularly grisly scene occurs at about 23 minutes, and hence there is good reason to believe that the majority of viewers found the scene too distasteful and discontinued watching. Further analysis of the viewing history of the viewers who terminated viewing at the 23 minutes time period may indicate that they have a similar taste in movies, for example, the majority of common movies that they have each watched to completion are of a particular genre, e.g., ‘indie drama’. Based on the outcome of such analysis, it can be decided that Movie X is possibly categorized in the wrong genre. Further analysis of the viewing history with regard to Movie X can be conducted to identify those viewers in the plurality of viewers who watched the movie in its entirety. And based on further analysis of the viewers who watched the movie to completion, it is possible to identify what other movies they have all watched to completion, whereby a common movie genre can be identified, for example ‘indie horror’. Accordingly, Movie X may be applicable for re-categorization under ‘indie horror’ and thus any viewer who indicates they do not want to view horror movies, or further still, based on the various embodiments presented herein, they are identified as not liking ‘horror’ movies, will not have Movie X recommended to them. And alternatively, a viewer that indicates, or has been identified as, having an interest in honor movies can have Movie X recommended to them.

In another embodiment, review of timestamps relating to an individual indicated that they are more likely to watch media content lasting approximately 1 hour, and as the length of media content exceeds 1 hour then the likelihood of viewing drops off accordingly, with no media content of a duration greater than 2 hours being watched to completion.

In a further embodiment, reviewing of one or more devices (e.g., viewing device 110) identified in a plurality of timestamps can indicate that a viewer prefers to watch content on a particular device (e.g., a laptop) and subsequent media can be identified that supports a format (e.g., display format, communication format, etc.) which is available for presentation of the particular device.

As previously mentioned, input component 125 can be utilized to provide comments, etc., regarding media content 122 presented on viewing device 110. Hence, where a timestamp is generated at the termination of viewing at approximately 23 minutes, a comment can be entered as to why the viewer terminated the viewing of Movie X and a timestamp can be generated with a reason as entered by input device 125, e.g., ‘did not like scene’, ‘considered scene inappropriate for children’, etc. Thus, while in the preceding paragraph mention is made based on all the common termination timestamps being at approximately 23 minutes it is possible to conject (e.g., by application of a suitable analysis technique, e.g., one based on artificial intelligence) a strong likelihood that the majority of viewers found the scene too distasteful and discontinued watching. By utilizing timestamps that include a comment, e.g., ‘did not like scene’, a greater level of confidence can be made regarding why viewing was terminated.

Feedback component 250 can be utilized to generate feedback 255 which can suggest future media content 122 for viewing on viewing device 110. In the above example, as mentioned, one or movie viewers can have the movies recommended to them altered based on determining termination of viewing, and further, associating timestamps with viewers comments. Hence, viewers who indicate ‘indie honor’ in their profile 280, (e.g., via input component 125) can be recommended Movie X for future viewing. While in a conventional system that does not monitor viewing interest, and report with associated timestamps, Movie X may continue to be presented for viewing by viewers who find particular content distasteful, inappropriate for a particular viewing group/age, etc.

MDC 135, as shown in FIG. 2, can further comprise a report component 260 which can generate one or more reports 265. As previously mentioned, the various data generated by utilizing timestamps, etc., can be utilized to facilitate understanding by parties having an interest in current/future available media content, where, for example, a television network providing content can utilize the viewing information to determine which media content is likely to capture a viewer's interest (and possibly increase advertising revenue owing to strong likelihood of viewers tuned into the network), what media content is likely to maintain a viewer's interest (e.g., the entirety of the media content is viewed), a specific time of day for particular media content to be provided, etc. By maximizing the likelihood that a viewer(s) will be interested in the media content provided by the television network, then the increased likelihood that a viewer(s) will watch the media content in its entirety, and revenue streams can be maximized such as commercials presented prior, during, and/or after, the media content is presented and thus increases revenue for the network. In another aspect, a participant in generation of media content, e.g., an entity providing media financing, can receive the timestamp data and, based thereon, can make future determinations on what sort of media content, e.g., films, are likely to be watched in their entirety and hence be a genre, etc., having a potential for a desired level of return on investment for the entity providing media financing. Similar reports 265 can be generated by report component 260 for distribution to other entities having an interest in media content, distribution, etc., such as a distributor of media content, a telecommunications service provider (e.g., cable network, satellite network, internet provider, etc.).

As previously mentioned, one or more profiles 280 can be stored for analysis. A profile 280 can comprise of a plurality of data associated with a viewer to facilitate monitoring of previously viewed, currently viewed and potential media content. In accordance with the various embodiments presented herein, profile 280 can include such data as viewer name(s), viewer location(s), preferred viewing location, viewing device(s), preferred viewing device, media content and associated timestamp(s), preferred media content, previously viewed media content, feedback data (e.g., via input component 125), reports generated (e.g., report 265), etc.

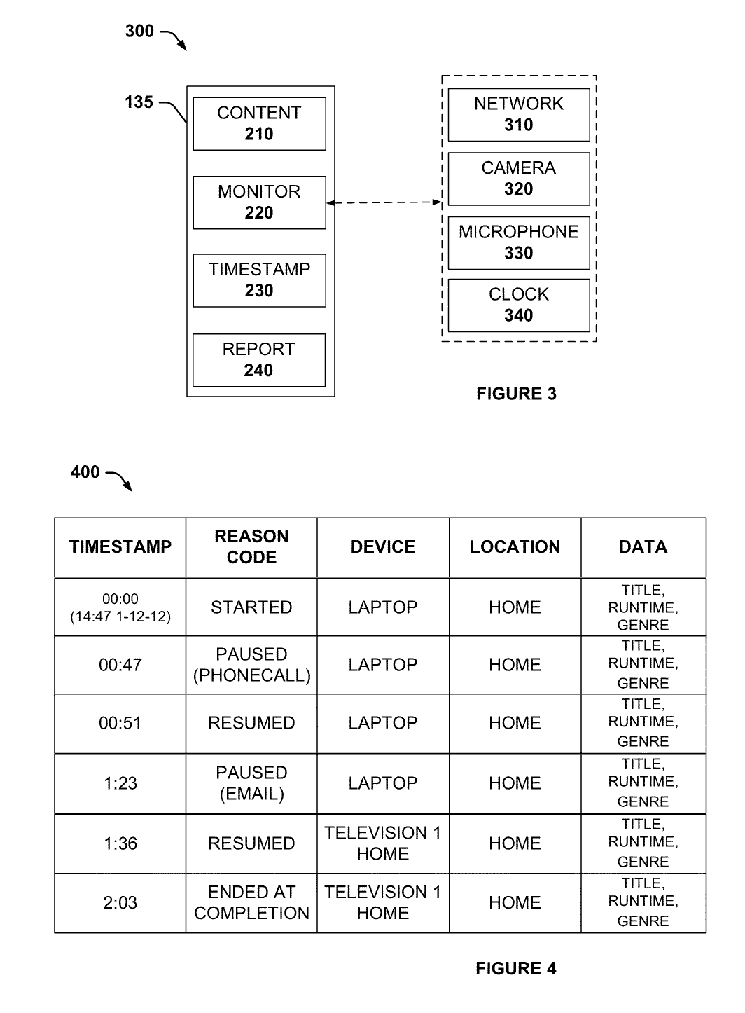

As illustrated in FIG. 3, MDC 135 can be associated with a plurality of devices/systems. For example, information can be obtained from network 310 to provide additional context to a timestamp(s) 245. For example, media content can be provided on viewing device 110 in association with a multimedia network 310, which not only has means for provision of media content, it is also configured to enable communications such as telephone, internet, messaging, etc. Hence, by monitoring various components comprising multimedia network 310, it is also possible to generate additional information for association with a timestamp(s) 245. For example, viewing of media content can be interrupted owing to a telephone call being received. Monitoring component 220, in conjunction with network component 310, can determine that viewing of media content 122 was interrupted owing to a phone call being received on a telecommunications system associated with network component 310. Accordingly, a timestamp 245 can be generated with an associated reason ‘phonecall’. The phonecall can be monitored, in conjunction with resumption of viewing of media content 122, whereby a timestamp 245 can be generated with an associated reason ‘phonecall ended’. Hence, by associating a reason with a timestamp 245, subsequent review of a plurality of timestamps associated with a viewer can facilitate filtering/parsing of timestamps based on any applicable criteria. For example, filtering out any timestamps having a reason associated therewith that can be attributed to an interruption, e.g., any timestamps associated with ‘phonecall’, ‘email’, etc. By filtering such timestamps, a better assessment of a viewer ceasing viewing of content for another reason, e.g., no longer interested in content, can be derived.

In another embodiment, a camera component 320 can be associated with MDC 135, whereby activity of a viewer, viewer(s), other persons, pet, etc., can be monitored. Camera component 320 can comprise a security camera system, motion detection system, or the like, whereby an interruption to viewing of media content 122 can result in generation of a timestamp 245, whereby the timestamp can be generated with ‘visitor’, ‘playing with dog’, etc., as determined by the camera component 320. In a further embodiment, camera component 320 can be utilized to determine the number of a people who are watching media content 122. For example, a family may be watching media content 122, e.g., a movie deemed to be suitable to viewing by the youngest member of the family group. Each member of the family can be identified (e.g., by a facial recognition application operating in conjunction with monitoring component 220, etc.) and thus when one or more family members are viewing the media content, a determination can be made as to which family member(s) are watching the media content, and accordingly, the level of interest in the media content can be assessed for each family member. Hence, in a situation where one, or more, of the family members are deemed to no longer be viewing media content (e.g., have left the room, are in room but performing other activity such as on computer searching the internet, etc.), respective timestamps can be generated for each family member based on their viewing, e.g., timestamp (@26 minutes) ‘mother left room’, timestamp (@56 minute) ‘daughter on internet’, timestamp (@61 minutes) ‘mother returned to room, resumed viewing’, etc.

In another embodiment, a microphone component 330 associated with viewing device 110 can be utilized to provide information regarding a viewer's activity. For example, the viewer may not be in the field of vision of camera 320 but feedback from a microphone component 330 can indicate that the person is still in the room but conducting conversation.

In a further embodiment, a clock component 340 can be utilized to facilitate understanding of a viewer's interest in media content 122. For example, a clock component 340 can supplement a timestamp 245 with date/time information, to enable understanding of interest in media content 122 based on a particular time during a day, a day of the week, a weekend, holiday, etc. Information from clock component 340 can be used to supplement other known information, for example, where a person has fallen asleep, camera component 320 can indicate that the room is in darkness owing to the late hour of viewing.

In another aspect, supplemental information can be gathered from a plurality of components in combination. For example, with the exemplary scenario of timestamp (@56 minute) ‘daughter on internet’ being generated, the daughter's internet activity can be monitored to provide further context. MDC 135, upon receiving a timestamp indicating that the daughter is on the internet, MDC 135 can request from the monitoring component 220 what content is being viewed on the internet. In response to the request, monitoring component 220 can, in association with network component 310, identify that the daughter is reviewing a website providing information about movies, and further, the movie information being reviewed on the internet can also determined. For example, based on such a query, network component 310 reports that the movie information regards Movie P. Further analysis by MDC 135 identifies that Movie P includes the same lead actress as Movie Q currently being watched by the family. Based on such an association, it is possible to make a determination that at least one member of the family is interested in movies with the lead actress in the cast, and hence, other movies which include the lead actress can be provided for future viewing recommendations by the at least one family member.

FIG. 4 illustrates an exemplary, non-limiting embodiment of utilizing timestamp(s) to facilitate monitoring of interest in media content and identifying other content of interest. Table 400 presents an exemplary table comprising a plurality of timestamps and associated information pertaining to a viewers viewing history of a particular movie. Table 400 can comprise of information compiled from any suitable source as previously described. For example, information comprising table 400 can be derived from one or more timestamps 245, data 137, request(s) 134, responses to questionnaire 127, profile information 280, etc. As illustrated in table 400, viewing of a movie was initiated at 14:47 PM on Jan. 12, 2012, with the content being viewed on a laptop at home, with the various media data (e.g., title, runtime, genre, etc.) shown in the data column. After 47 minutes of viewing the movie is paused owing to a phonecall being received, with resumption of viewing occurring at 00:51. At 1:23 viewing is again paused owing to an email being received. At 1:36 viewing is resumed, but this time on television 1 in the home, where the movie is viewed to completion. It is to be appreciated that table 400 can comprise of any information pertinent to the viewing history of a particular movie. The information comprising table 400 can be analyzed (e.g., by MDC 135) and based thereon, future media content can be recommended for viewing.

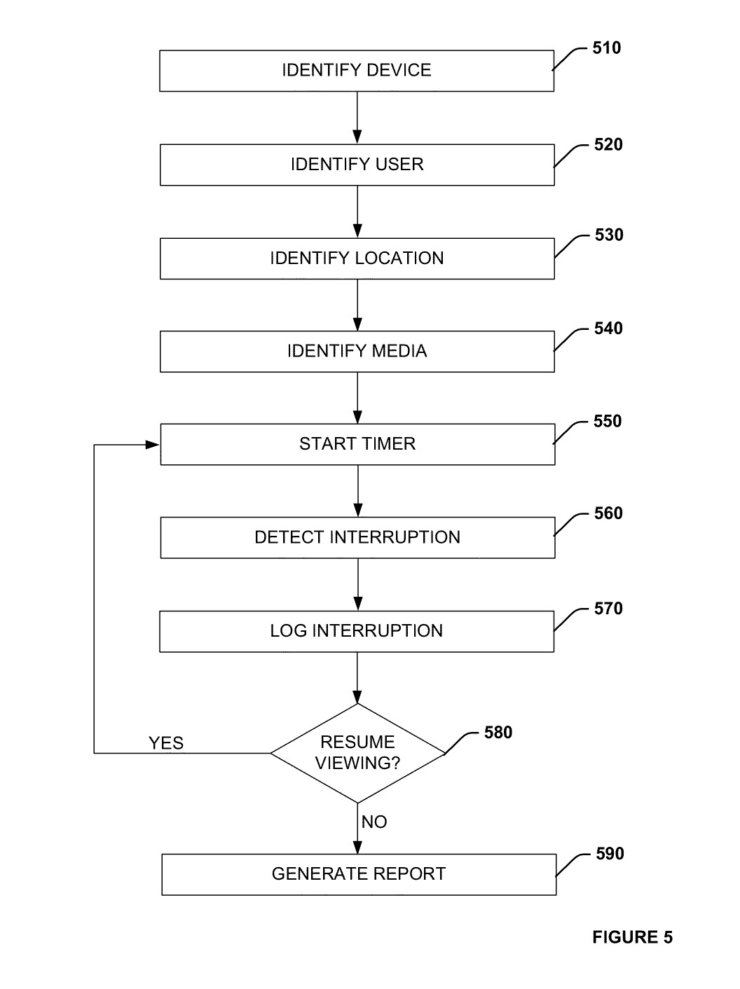

FIG. 5 presents a flow diagram illustrating an exemplary, non-limiting embodiment to facilitate monitoring of interest in media content and identifying other content of interest. At 510 a device (e.g., viewing device 110) can be identified, and if available, at 520 a user associated with the device can be identified.

At 530, a location of viewing (e.g., based on location of viewing device 110 if being used in a static manner (e.g., a television), GPS of viewing device 110, communication network to provide media content (e.g., satellite 140, cable 150, DVD 160, other 170, etc.)) for the viewing device can be determined.

At 540, the media content (e.g., media content 122) to be viewed (e.g., via display 120 of viewing device 110) can be identified and any data 137 associated therewith can be obtained (e.g., title, duration, genre, actor, actress, etc.).

At 550, upon commencement of viewing of the media content (e.g., media content 122 is streamed from media source 132), a clock can be initiated to facilitate generation of one or more timestamps (e.g., timestamp 245) as necessary during the presentation of the media content on the viewing device.

At 560, interruption of viewing of the media content can be detected (e.g., by viewing device 110, media source component 132, MDC 135, etc.) whereupon a timestamp 245 can be generated. In an exemplary scenario, viewing is interrupted owing to a phonecall being received, and the timestamp can be supplemented with an associated reason ‘phonecall’ providing further information as to why the viewing of the media content was interrupted.

At 570, the timestamp (and associated information, e.g., a reason code) can be stored (e.g., for later downloading from viewing device 110, at data store 133, etc.) by a component monitoring viewing (e.g., MDC 135) in conjunction with a data storage (e.g., data store 133) where the timestamp can be associated with a viewing profile (e.g., profile(s) 280).

At 580 a determination can be made regarding whether viewing of the media content is resumed or not. In the event of viewing being resumed, flow can return to 550 where a timestamp can be generated indicating viewing has been resumed. Flow can then continue until the next interruption in viewing is determined, or the media content is viewed in its entirety. In response to a determination that viewing of media content is terminated, flow can proceed to 590 whereupon a report can be generated (e.g., report 265 generated by report generation component 260) which provides a viewing history of the media content along with any other viewing history that may pertain to the viewer and/or the media content. The report can be utilized to determine further recommended viewing based on the viewing history for presentment to the viewer. Further, the report can be forwarded to any entity having an interest in one or more viewing histories associated with a particular media content, where such entity can comprises of a television network, a television channel, a telecommunication provider, a provider of funds for media content, etc. A report can comprise a plurality of timestamps and associated information (e.g., as shown in table 400) from which viewing history information can be extracted.

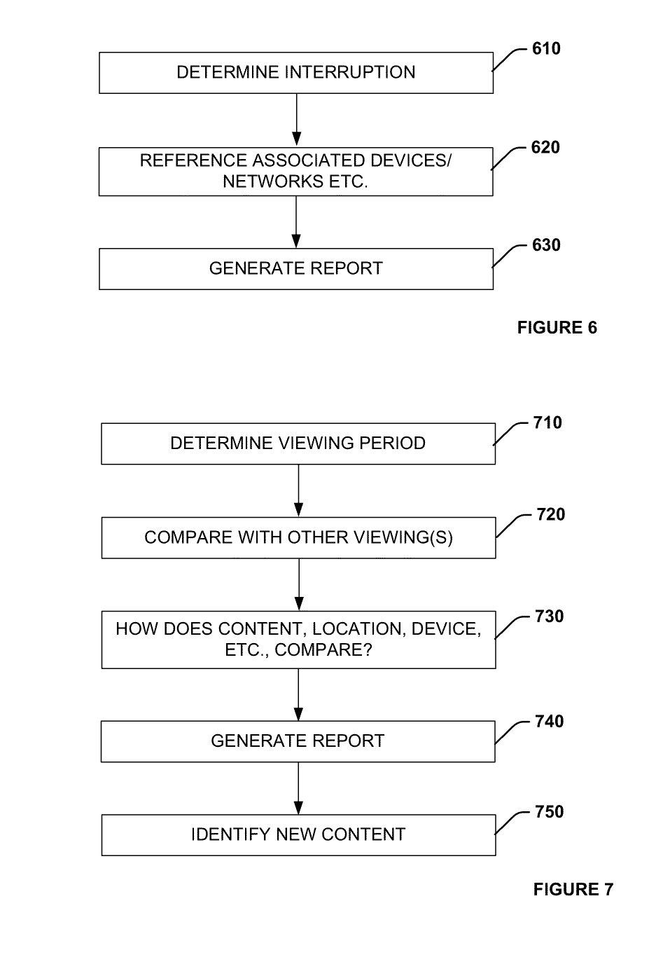

FIG. 6 presents a flow diagram illustrating an exemplary, non-limiting embodiment to facilitate monitoring of interest in media content and identifying other content of interest. At 610 interruption of viewing of media content (e.g., media content 122) can be determined (e.g., by viewing device 110, media source component 132, MDC 135, etc.). A timestamp (e.g., timestamp 245) can be generated to indicate the interruption in viewing of the media content. Further, information regarding why viewing was interrupted can be provided (e.g., as a reason code associated with the timestamp). In an exemplary scenario, a viewer can provide information regarding their viewing of the media content via an input component (e.g., input component 125) associated with a device (e.g., viewing device 110) on which they were viewing the media content. In another embodiment, information regarding a communication network (e.g., any of satellite network 140, cable network 150, DVD 160, other network 170) can be utilized to provide further information regarding viewing of the media content. For example, knowledge of a communications network on which media content is being streamed (e.g., between media source 132 and viewing device 110) can be utilized to identify that the content is being streamed to a residential location, a business, a hotel, etc. Furthermore, ancillary devices (e.g., a camera 320 (e.g., webcam, security camera), a microphone 330, input device 125, phone or email associated with a bundled communication system, etc.) can be utilized to provide further information regarding viewing of media content. For example, a timestamp can be supplemented with viewer paused viewing owing to incoming phonecall, paused viewing owing to an email being received, viewer has left the room, viewer is on internet, viewer has company, activity of more than one viewers watching media content, etc.

At 630, the various information obtained regarding a viewer's interest in a particular media content and/or viewing history can be compiled and a report generated (e.g., by report component 260). As previously mentioned, the report can be utilized in providing further viewing content for a viewer(s) as well as being forwarded for analysis to other entities such as a television network, a television channel, a telecommunication provider, a provider of funds for media content, etc.,

FIG. 7 presents a flow diagram illustrating an exemplary, non-limiting embodiment to facilitate monitoring of interest in media content and identifying other content of interest. At 710 interest in media content (e.g., media content 122) can be determined based on information and data gathered from one or more sources associated with viewing of the media content. As previously mentioned, one or more timestamps (e.g., timestamp 245) can be generated at any event associated with viewing of the media content, e.g., viewing paused, viewing resumed, viewing on device X, viewing on device Y, phonecall received, email received, visitor, asleep, etc. The timestamps (and associated data) can be reviewed to determine whether the media content was viewed in its entirety, whether viewing was interrupted but the media content was watched in its entirety, whether viewing was terminated, etc. (as illustrated in table 400).

At 720, to facilitate greater understanding of content viewed by a viewer, viewing device(s), viewing location(s), etc., gathered data (e.g., table 400) can be compared (e.g., by MDC 135) with other data gathered for a particular viewer (e.g., stored in viewer profile 280), as well as comparing the historical data gathered for the viewer with historical data gathered from one or more other viewers (e.g., stored in a plurality of profiles 280). Hence, by compiling a viewing history comprising timestamps and associated information/data it is possible to perform complex analysis of viewing history to facilitate improved recommendation of media content for future viewing as well as complex data mining for entities concerned with current and future media content such as a television network, a television channel, a telecommunication provider, a provider of funds for media content, etc. Information in the viewing history can be supplemented with data obtained from a content request (e.g., content request 134), data (e.g., data 137) gathered throughout the system (e.g., any of systems 100, 200, 300), responses received to questionnaire(s) (e.g., questionnaire 127), data input (e.g., via input component 125), etc.

At 730, a plethora of determinations can be performed such as identifying what sort of media content is likely to be viewed on a particular device? (e.g., laptop used for travel, a laptop primarily used in a home, a television located in a family room, a television located in a child's room, a television located in a basement, etc.), what communication network (e.g., satellite network 140, cable network 150, DVD 160, other network 170, etc.) is the media content being viewed on? What time of day is a viewer likely to watch media content? What time of day is a viewer likely to watch media content to completion? Is there a common point during viewing media content that viewers are terminating viewing?, etc. Given the wealth of data that can be obtained by monitoring viewing history (e.g., based on timestamps) the correlations, data mining, etc., that can be conducted with the viewing histories, etc., are myriad.

At 740, a report can be generated (e.g., report 265 by report generation component 260) presenting information determined from analysis of the timestamp(s), associated information/data, profile(s) data, content request(s), questionnaire(s) response(s), etc. The report can be forwarded to any interested entity. Further feedback (e.g., feedback 255) can be generated (e.g., by feedback component 250) for transmission to a device (e.g., viewing device 110) presenting media content. Further, a viewer's profile (e.g., profile 280) can be updated with the report and/or the feedback.

At 750, new media content can be identified (e.g., by MDC 135) for recommendation to a viewer based on the analysis of their viewing history.

It should be appreciated that while the methodologies provided above are shown and described as a series of acts for purposes of simplicity, such methodologies are not limited by the order of acts, as some acts can, in accordance with one or more aspects, occur in different orders and/or concurrently with other acts from that shown and described herein. For example, those skilled in the art will understand and appreciate that other methodologies could alternatively be represented as a series of interrelated states or events, such as in a state diagram. Moreover, not all illustrated acts may be required to implement a methodology in accordance with one or more aspects.

Hence, based on the various exemplary, non-limiting embodiments presented herein, media content determination systems can be developed to facilitate improved content recommendation and analysis compared with conventional systems. The various exemplary, non-limiting embodiments utilize timestamps and associated information to facilitate in-depth knowledge of a viewing history of a viewer.

### Exemplary Computing Environments

Embodiments, systems, and components described herein, relating to media content determination can include computer or network components such as servers, clients, controllers, communications modules, mobile computers, wireless components, control components and so forth which are capable of interacting across a network. Computers and servers include one or more processors—electronic integrated circuits that perform logic operations employing electric signals—configured to execute instructions stored in media such as random access memory (RAM), read only memory (ROM), a hard drives, as well as removable memory devices, which can include memory sticks, memory cards, flash drives, external hard drives, and so on.

Similarly, the term computer as used herein can include functionality that can be shared across multiple components, systems, and/or networks. As an example, one or more computers can communicate and cooperate with various network devices across the network, wherein the network can be confined to an on-board configuration incorporated into the platform of interest or the network can comprise an extended system, and the like. This can include substantially any type of control, communications module, computer, Input/Output (I/O) device, sensor, actuator, and human machine interface (HMI) that communicate via the network, which includes control, automation, and/or public networks.

The network can include public networks such as the internet, intranets, automation networks, wireless networks, serial protocols, and so forth. In addition, the network devices can include various possibilities (hardware and/or software components). These include components such as switches with virtual local area network (VLAN) capability, LANs, WANs, proxies, gateways, routers, firewalls, virtual private network (VPN) devices, servers, clients, computers, configuration tools, monitoring tools, and/or other devices.

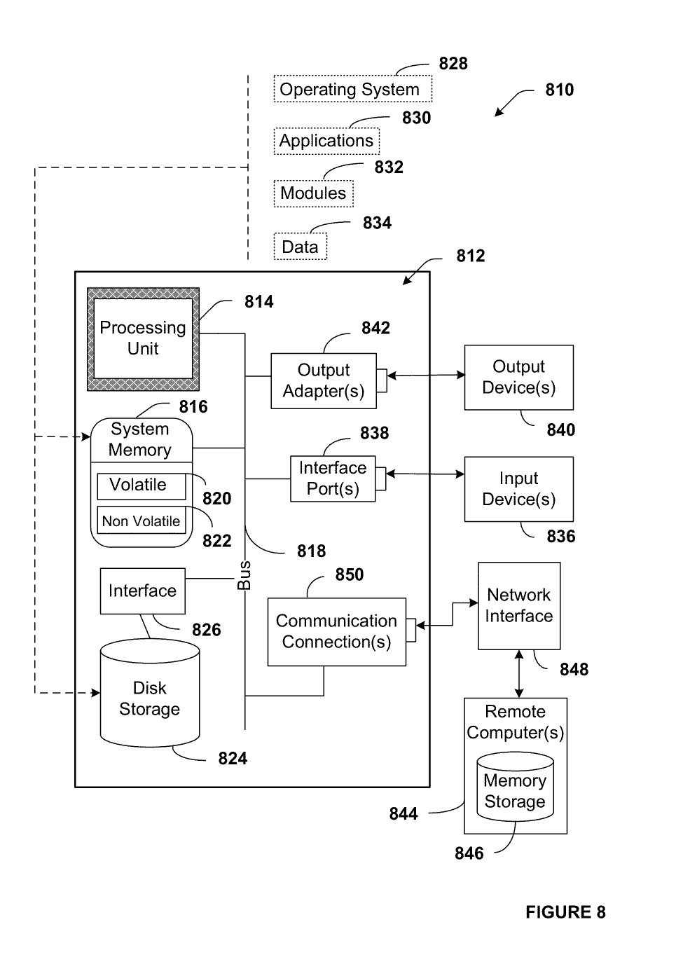

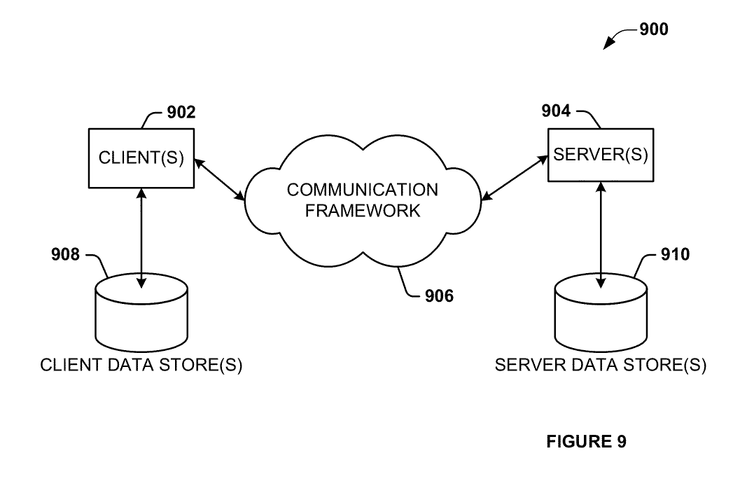

In order to provide a context for the various aspects of the disclosed subject matter, FIGS. 8 and 9 as well as the following discussion are intended to provide a brief, general description of a suitable environment in which the various aspects of the disclosed subject matter may be implemented.

With reference to FIG. 8, an example environment 810 for implementing various aspects of the aforementioned subject matter includes a computer 812. The computer 812 includes a processing unit 814, a system memory 816, and a system bus 818. The system bus 818 couples system components including, but not limited to, the system memory 816 to the processing unit 814. The processing unit 814 can be any of various available processors. Dual microprocessors and other multiprocessor architectures also can be employed as the processing unit 814.

The system bus 818 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 816 includes volatile memory 820 and nonvolatile memory 822. The basic input/output system (BIOS), containing the basic routines to transfer information between elements within the computer 812, such as during start-up, is stored in nonvolatile memory 822. By way of illustration, and not limitation, nonvolatile memory 822 can include read only memory (ROM), programmable ROM (PROM), electrically programmable ROM (EPROM), electrically erasable PROM (EEPROM), or flash memory. Volatile memory 820 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 812 also includes removable/non-removable, volatile/non-volatile computer storage media. FIG. 8 illustrates, for example a disk storage 824. Disk storage 824 includes, but is not limited to, devices like a magnetic disk drive, floppy disk drive, tape drive, Jaz drive, Zip drive, LS-100 drive, flash memory card, or memory stick. In addition, disk storage 824 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 824 to the system bus 818, a removable or non-removable interface is typically used such as interface 826.

It is to be appreciated that FIG. 8 describes software that acts as an intermediary between users and the basic computer resources described in suitable operating environment 810. Such software includes an operating system 828. Operating system 828, which can be stored on disk storage 824, acts to control and allocate resources of the computer system 812. System applications 830 take advantage of the management of resources by operating system 828 through program modules 832 and program data 834 stored either in system memory 816 or on disk storage 824. It is to be appreciated that one or more embodiments of the subject disclosure can be implemented with various operating systems or combinations of operating systems.

A user enters commands or information into the computer 812 through input device(s) 836. Input devices 836 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 814 through the system bus 818 via interface port(s) 838. Interface port(s) 838 include, for example, a serial port, a parallel port, a game port, and a universal serial bus (USB). Output device(s) 840 use some of the same type of ports as input device(s) 836. Thus, for example, a USB port may be used to provide input to computer 812, and to output information from computer 812 to an output device 840. Output adapter 842 is provided to illustrate that there are some output devices 840 like monitors, speakers, and printers, among other output devices 840, which require special adapters. The output adapters 842 include, by way of illustration and not limitation, video and sound cards that provide a means of connection between the output device 840 and the system bus 818. It should be noted that other devices and/or systems of devices provide both input and output capabilities such as remote computer(s) 844.

Computer 812 can operate in a networked environment using logical connections to one or more remote computers, such as remote computer(s) 844. The remote computer(s) 844 can be a personal computer, a server, a router, a network PC, a workstation, a microprocessor based appliance, a peer device or other common network node and the like, and typically includes many or all of the elements described relative to computer 812. For purposes of brevity, only a memory storage device 846 is illustrated with remote computer(s) 844. Remote computer(s) 844 is logically connected to computer 812 through a network interface 848 and then physically connected via communication connection 850. Network interface 848 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 850 refers to the hardware/software employed to connect the network interface 848 to the bus 818. While communication connection 850 is shown for illustrative clarity inside computer 812, it can also be external to computer 812. The hardware/software necessary for connection to the network interface 848 includes, for exemplary purposes only, internal and external technologies such as, modems including regular telephone grade modems, cable modems and DSL modems, ISDN adapters, and Ethernet cards.

FIG. 9 is a schematic block diagram of a sample-computing environment 900 with which the disclosed subject matter can interact. The system 900 includes one or more client(s) 910. The client(s) 910 can be hardware and/or software (e.g., threads, processes, computing devices). The system 900 also includes one or more server(s) 930. The server(s) 930 can also be hardware and/or software (e.g., threads, processes, computing devices). The servers 930 can house threads to perform transformations by employing one or more embodiments as described herein, for example. One possible communication between a client 910 and a server 930 can be in the form of a data packet adapted to be transmitted between two or more computer processes (e.g., a process running on viewing device 110 and a process running on an external system, e.g., MDC 135). System 900 includes a communication framework 950 that can be employed to facilitate communications between the client(s) 910 and the server(s) 930. The client(s) 910 are operably connected to one or more client data store(s) 960 that can be employed to store information local to the client(s) 910. Similarly, the server(s) 930 are operably connected to one or more server data store(s) 940 that can be employed to store information local to the servers 930.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media. Further, computer instructions/operations can be stored in memory in the form of non-transitory, or tangible, computing elements (e.g., computer readable storage medium), where such instructions/operations can be executed, e.g., by a processor, to facilitate operation of one or more exemplary, non-limiting embodiments, as presented herein.

As used in this application, the terms “component,” “system,” “platform,” “layer,” “controller,” “terminal,” “station,” “node,” “interface” are intended to refer to a computer-related entity or an entity related to, or that is part of, an operational apparatus with one or more specific functionalities, wherein such entities can be either hardware, a combination of hardware and software, software, or software in execution. For example, a component can be, but is not limited to being, a process running on a processor, a processor, a hard disk drive, multiple storage drives (of optical or magnetic storage medium) including affixed (e.g., screwed or bolted) or removably affixed solid-state storage drives; an object; an executable; a thread of execution; a computer-executable program, and/or a computer. By way of illustration, both an application running on a server and the server can be a component. One or more components can reside within a process and/or thread of execution, and a component can be localized on one computer and/or distributed between two or more computers. Also, components as described herein can execute from various computer readable storage media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that provides at least in part the functionality of the electronic components. As further yet another example, interface(s) can include input/output (I/O) components as well as associated processor, application, or Application Programming Interface (API) components. While the foregoing examples are directed to aspects of a component, the exemplified aspects or features also apply to a system, platform, interface, layer, controller, terminal, and the like.

What has been described above includes examples of the various embodiments. It is, of course, not possible to describe every conceivable combination of components or methodologies for purposes of describing the disclosed subject matter, but one of ordinary skill in the art may recognize that many further combinations and permutations of the various embodiments are possible. Accordingly, the disclosed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the disclosed subject matter. In this regard, it will also be recognized that the disclosed subject matter includes a system as well as a computer-readable medium having computer-executable instructions for performing the acts and/or events of the various methods of the disclosed subject matter.

In addition, while a particular feature of the disclosed subject matter may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising”.

As used herein, the terms “to infer” and “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

In addition, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Furthermore, the term “set” as employed herein excludes the empty set; e.g., the set with no elements therein. Thus, a “set” in the subject disclosure includes one or more elements or entities. As an illustration, a set of controllers includes one or more controllers; a set of data resources includes one or more data resources; etc. Likewise, the term “group” as utilized herein refers to a collection of one or more entities; e.g., a group of nodes refers to one or more nodes.

In this application, the word “exemplary” is used to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

What is claimed is:

1. A system, comprising:
a processor coupled to a memory that facilitates execution of computer-executable components, comprising:
a timestamp component configured to determine interruption in viewing of media content, and generate a timestamp indicating the interruption; and
a media determination component configured to review the timestamp in conjunction with at least one other timestamp associated with the media content, and determine, based on the review, future media content for potential viewing.

2. The system of claim 1, wherein the media content comprises a movie, a documentary, a news program, television program, an episode in a television series, computer game, audio content, a digital image, or a digitally rendered photograph.

3. The system of claim 1, the computer-executable components further comprising a report component configured to generate a report comprising the review.

4. The system of claim 1, wherein the timestamp is supplemented with data relating to the viewing of the media content.

5. The system of claim 4, wherein the data indicates at least one of a device utilized to view the media content, a location of viewing the media content, a network facilitating delivery of the media content, a time of viewing the media content, a cause of interruption in viewing of the media content, a duration of interruption in viewing of the media content, or whether the media content was viewed to completion.

6. The system of claim 1, wherein the media determination component is further configured to receive information from at least one device associated with a network facilitating delivery of the media content, wherein the at least one device being a camera, a webcam, a security camera, a phone monitoring component, an email monitoring component, or an internet monitoring component.

7. The system of claim 6, wherein the information comprises at least one of a phone call being received, an email being received, a visitor, an activity of a viewer watching the media content, or internet activity of a viewer watching the media content.

8. The system of claim 1, the computer-executable components further comprising an input component, the input component configured to receive viewer input regarding the media content, wherein the viewer input supplements information comprising the timestamp.

9. The system of claim 1, the computer-executable components further comprising a data storage component configured to store at least one of the timestamp, the media content, a user profile, a report, feedback, viewer input, or a response to a questionnaire.

10. The system of claim 1, the computer-executable components further comprising a camera component configured to identify at least one viewer of the media content.

11. The system of claim 10, wherein the camera component is further configured to identify a position of the at least one viewer during presentation of the media content.

12. A method, comprising:
determining, by a system comprising a processor, an interruption in viewing of media content;
generating a timestamp indicating the interruption;
analyzing the timestamp in conjunction with at least one other timestamp associated with the media content; and
determining, based on the analyzing, future media content for potential viewing.

13. The method of claim 12, wherein the media content comprising a movie, a documentary, a news program, television program, an episode in a television series, computer game, audio content, a digital image, or a digitally rendered photograph.

14. The method of claim 12, further comprising supplementing the timestamp with data relating to viewing of the media content.

15. The method of claim 14, wherein the data indicating at least one of a device facilitating viewing of the media content, a location of viewing the media content, a network facilitating delivery of the media content, a time of viewing the media content, a cause of interruption in viewing of the media content, a duration of interruption in viewing of the media content, or whether the media content was viewed to completion.

16. The method of claim 12, further comprising receiving information from at least one device associated with a network facilitating delivery of the media content, wherein the at least one device being a camera, a webcam, a security camera, a phone monitoring component, an email monitoring component, or an internet monitoring component.

17. The method of claim 12, further comprising storing at least one of the timestamp, a user profile, a report, feedback, viewer input, or a response to a questionnaire.

18. A non-transitory computer readable storage medium comprising computer executable instructions that, in response to execution, cause a computing system comprising a processor to perform operations, comprising:
determining an interruption in viewing of media content;
generating a timestamp indicating the interruption;
analyzing the timestamp in conjunction with at least one other timestamp associated with the media content; and
determining, based on the analyzing, future media content for potential viewing.

19. The non-transitory computer readable storage medium of claim 18, wherein the operations further comprise:
supplementing the timestamp with data relating to viewing of the media content.

20. The non-transitory computer readable storage medium of claim 19, wherein the data indicating at least one of a device facilitating viewing of the media content, a location of viewing the media content, a network facilitating delivery of the media content, a time of viewing the media content, a cause of interruption in viewing of the media content, a duration of interruption in viewing of the media content, or whether the media content was viewed to completion.
